(19) United States
(12) Patent Application Publication
(10) Pub. No.: US 2010/0182615 A1
(43) Pub. Date: Jul. 22, 2010

(54) IMAGE FORMING APPARATUS AND CONTROL METHOD OF THE SAME

(75) Inventor: Akihisa Nakamura, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/690,610

(22) Filed: Jan. 20, 2010

Related U.S. Application Data
(60) Provisional application No. 61/146,020, filed on Jan. 21, 2009.

(51) Int. Cl. G06K 15/02; G06F 3/12

(52) U.S. Cl. 358/1.2; 358/1.15

(57) ABSTRACT

An image processor selectively sets a first processing function for image data of a first page and a second processing function for the image data of the first page and image data of a second page. A CPU detects a processing load of the image processor. In addition, the CPU instructs the image processor to set the first processing function if the detected load is equal to or higher than a predetermined value. In addition, the CPU instructs the image processor to set the second processing function if the detected load is less than the predetermined value.

### CROSS-REFERENCE TO RELATED APPLICATION

This application is based upon and claims the benefit of priority from U.S. Provisional Application No. 61/146,020, filed on Jan. 21, 2009, the entire contents of which are incorporated herein by reference.

### TECHNICAL FIELD

A disclosed embodiment relates to an image forming apparatus and a control method of the same having, in relation to image data, for example, a function of compression.

### BACKGROUND

An image forming apparatus can print image data scanned from a document or image data input from an external device (for example, a personal computer) connected to a network on a sheet or compress the image data into a smaller size to be stored.

With regard to image data compression, faster processing is preferable.

### SUMMARY

According to an aspect of the invention, there is provided an image forming apparatus including: an image processor configured to selectively set a first processing function of performing a part of processing on first image data, and a second processing function of performing a part of processing on second image data while performing the part of processing on the first image data; and a controller configured to detect a processing load of the image processor, instruct the image processor to set the first processing function if the detected load is equal to or higher than a predetermined value, instruct the image processor to set the second processing function if the detected load is less than the predetermined value, and perform the residual processing on the first image data while the image processor performs the part of processing on the first image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate presently embodiment of the invention, and together with the general description given above and the detailed description of the preferred embodiments given below, serve to explain the principles of the invention.

FIG. 1 is a block diagram of a control circuit according to an embodiment.

FIG. 2 is a diagram showing a state where functions of an image processor in FIG. 1 are changed.

FIG. 3 is a flowchart for explaining an operation of a controller according to the embodiment.

FIG. 4 is a flowchart for explaining an operation of the image processor according to the embodiment.

FIG. 5 is a time chart showing an operation of each resource when a processing load of the image processor is equal to or higher than a predetermined value according to the embodiment.

FIG. 6 shows an operation of each resource when the processing load of the image processor is less than the predetermined value according to the embodiment.

FIG. 7 is a block diagram showing a modified example of the control circuit according to the embodiment.

FIG. 8 is a block diagram showing another modified example of the control circuit according to the embodiment.

### DETAILED DESCRIPTION

Hereinafter, an embodiment of the invention will be described with reference to the accompanying drawings.

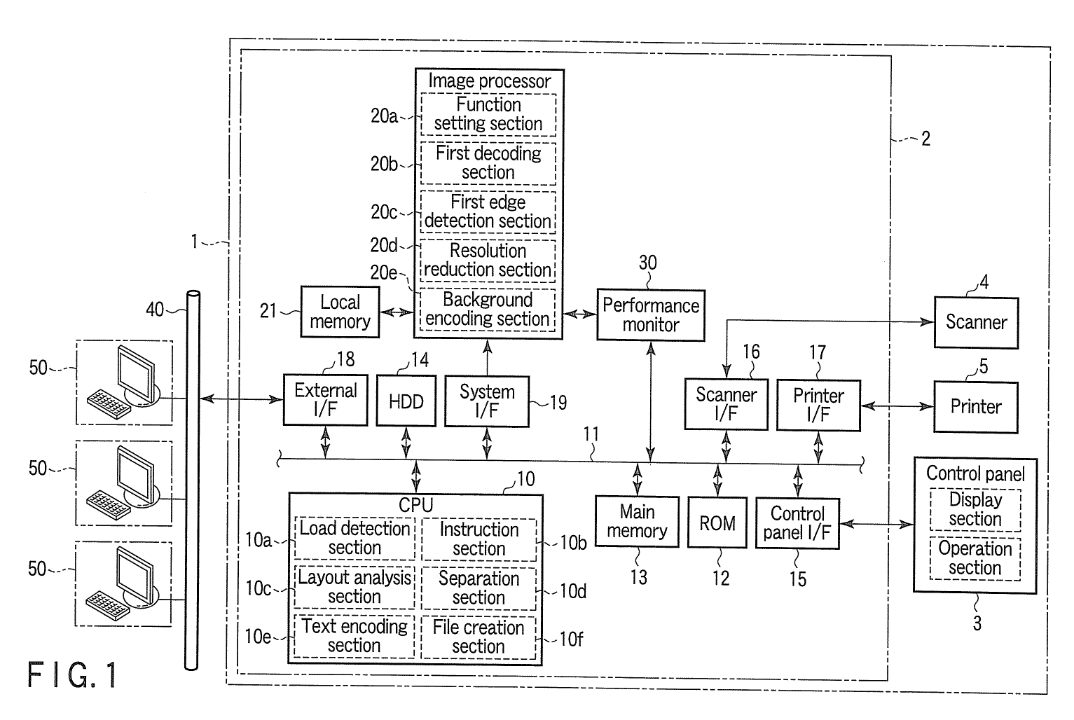

In FIG. 1, reference numeral 1 denotes a multi-function image forming apparatus, a so-called MFP. The MFP 1 combines a plurality of functions such as a copy function, a scan function, and a print function. In addition, the MFP 1 includes an image processing circuit 2, a control panel 3, a scanner 4, and a printer (also called a printer engine) 5.

The image processing circuit 2 includes a CPU 10 as a controller, a data bus 11 for data transmission, a ROM 12 for program storage, a main memory (RAM) 13 for data storage, a hard disk drive (HDD) 14, a control panel interface (I/F) 15, a scanner interface (I/F) 16, a printer interface (I/F) 17, an external interface (I/F) 18, a system interface (I/F) 19, an image processor 20, a local memory 21, and a performance monitor 30.

The control panel 3 includes a display section and an operation section for setting an operation condition of the MFP 1 and displaying an operation state of the MFP 1. The scanner 4 optically reads an image of a document set on the MFP 1. The printer 5 prints the image data on a sheet.

A plurality of client terminals, for example, personal computers 50 are connected to the external interface 18 via a network cable 40. The personal computers 50 generate image data using various installed application programs (word processor, spreadsheet, presentation, DTP software, and the like) and transmit the generated image data to the MFP 1.

The image processor 20 is a dynamic reconfigurable processor, and selectively sets one from a first processing function (for example, a single-page task processing function) and a second processing function (for example, a plural-page task processing function) according to an instruction from the CPU 10. The first processing function is a function of performing a part of high compression on first image data input from the scanner 4 or the personal computer 50. The second processing function is a function which, while the part of high compression is being performed on the first image data, performs a part of high compression on second image data supplied from the scanner 4 or the personal computer 50 in the spare time of this compression.

The part of high compression of the first image data includes first decoding, first edge detection, resolution reduction, and background encoding. The first decoding decodes the first image data into JPEG format. The first edge detection detects edges of a text image region of the JPEG image data decoded and decoded by the first decoding. The resolution reduction reduces the resolution of the JPEG image data decoded and decoded by the first decoding. The background encoding encodes and compresses background image data separated by separation described later into JPEG format.

The residual high compression of first image data includes layout analysis, the separation, text encoding, and file creation. The layout analysis analyzes a layout of the text image region of the JPEG image data decoded by the first decoding. The separation separates the image data decoded by the first decoding into text image data and background image data depending on a processing result of the layout analysis and a processing result of the resolution reduction. The text encoding compresses the text image data separated by the separation by performing MMR encoding. The file creation creates the MMR text image data encoded by text encoding and the JPEG background image data encoded by the background encoding into PDF files.

The part of high compression of the second image data includes second decoding and second edge detection. The second decoding decodes the second image data into JPEG format. The second edge detection detects edges of a text image region of the image data decoded by the second decoding.

In addition, the first image data is image data of a first page. The second image data is image data of a second page following the first image data. The MMR encoding is a compression algorithm suitable for text image data. The JPEG encoding is a compression algorithm suitable for background image data.

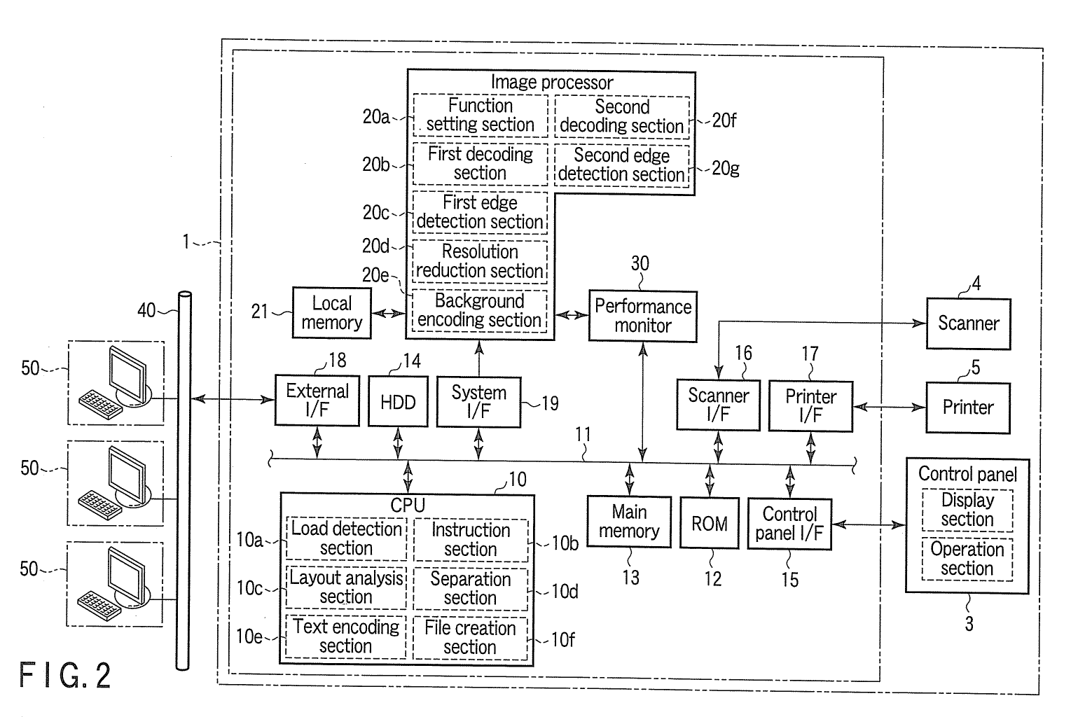

The image processor 20 includes a function setting section 20a as shown in FIG. 1. The function setting section 20a sets one of the first processing function and the second processing function according to an instruction from the CPU 10. In addition, when the first processing function is set, as illustrated in FIG. 1, the image processor 20 sets a first decoding section 20b for the first decoding, a first edge detection section 20c for the first edge detection, a resolution reduction section 20d for the resolution reduction, and a background encoding section 20e for the background encoding. In addition, when the second processing function is set, as illustrated in FIG. 2, the image processor 20 sets the first decoding section 20b, the first edge detection section 20c, the resolution reduction section 20d, and the background encoding section 20e, and also sets a second decoding section 20f for the second decoding and a second edge detection section 20g for the second edge detection.

The CPU 10 detects a processing load of the image processor 20 on the basis of a monitoring result of the performance monitor 30, instructs the image processor 20 to set the first processing function if the detected load is equal to or higher than a predetermined value, and instructs the image processor 20 to set the second processing function if the detected load is less than the predetermined value. In addition, while the image processor 20 performs the part of high compression on the image data of the first page, in parallel with this, the CPU 10 performs the residual high compression on the image data of the first page.

In other words, the CPU 10 includes a load detection section 10a and an instruction section 10b.

The load detection section 10a detects the processing load of the image processor 20 on the basis of the monitoring result of the performance monitor 30. The instruction section 10b instructs the image processor 20 to set the first processing function if the load detected by the load detection section 10a is equal to or higher than the predetermined value, and instructs the image processor 20 to set the second processing function if the load detected by the load detection section 10a is less than the predetermined value. In addition, the CPU 10 includes a layout analysis section 10c, a separation section 10d, a text encoding section 10e, and a file creation section 10f as units for performing the residual high compression on the image data of the first page.

The image processor 20 has, in addition to the high compression function of image data, various image processing functions. The performance monitor 30 calculates the incidence of events in the image processor 20. If the incidence is high, the processing load of the image processor 20 is large. If the incidence is low, the pressing load of the image processor 20 is small.

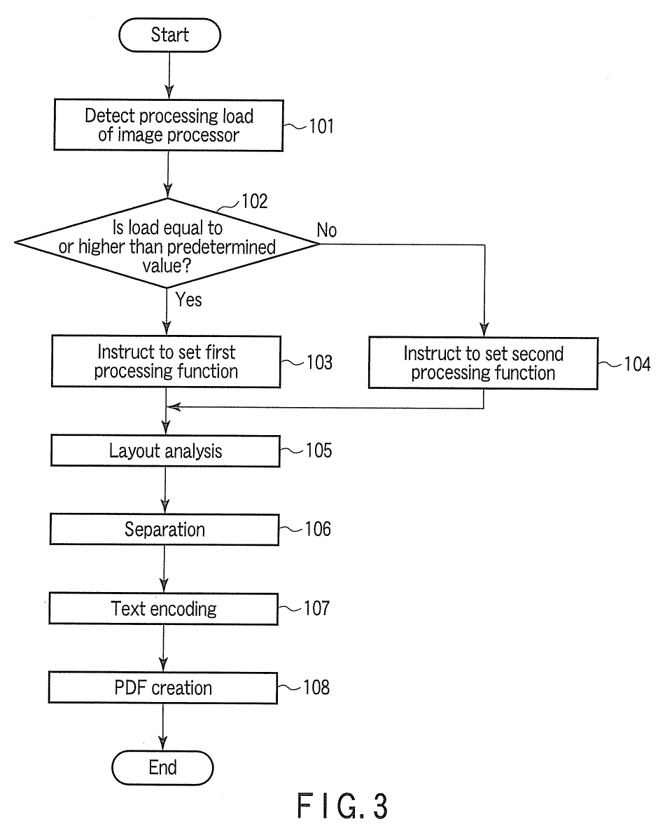

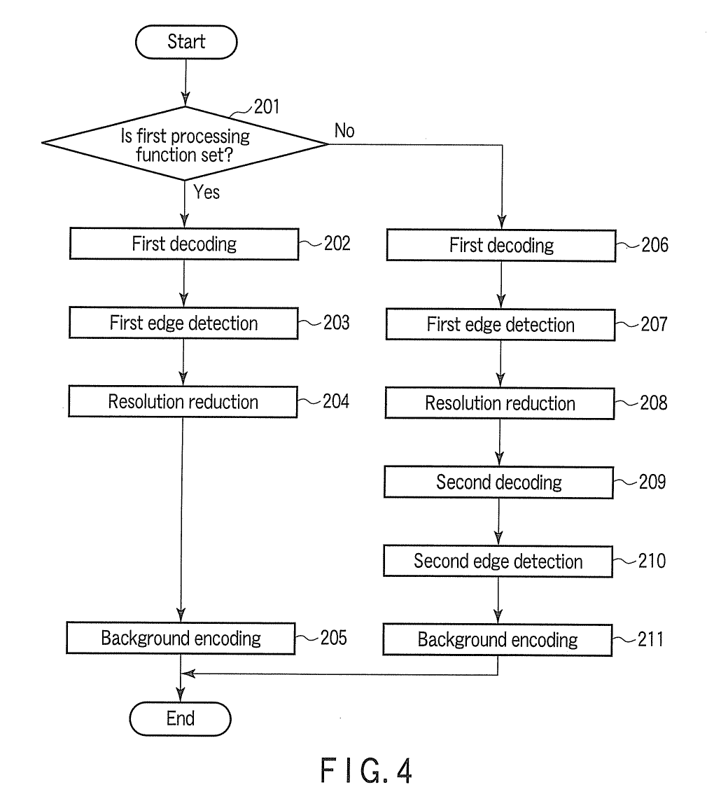

Next, operations thereof will be described. An operation of the CPU 10 is shown in FIG. 3. An operation of the image processor 20 is shown in FIG. 4. The CPU 10 detects the processing load of the image processor 20 on the basis of the monitoring result of the performance monitor 30 (Act 101). If the detected load is equal to or higher than the predetermined value (YES in Act 102), the CPU 10 instructs the image processor 20 to set the first processing function (Act 103), and if the detected load is less than the predetermined value (NO in Act 102), the CPU 10 instructs the image processor 20 to set the second processing function (Act 104). In addition, in parallel with the part of high compression performed by the image processor 20 on the image data of the first page, the CPU 10 performs the residual high compression on the image data of the first page, that is, the layout analysis, the separation, the text encoding, and the PDF file creation (Acts 105, 106, 107, and 108).

If the image processor 20 is instructed to set the first processing function by the CPU 10 (YES in Act 201), it performs the part of high compression on the image data of the first page, that is, the first decoding, the first edge detection, the resolution reduction, and the background encoding (Acts 202, 203, 204, and 205).

A single-page task processing program needed to perform the first decoding, the first edge detection, the resolution reduction, and the background encoding is stored in the ROM 12. The image processor 20 reads the single-page task processing program from the ROM 12 when setting the first processing function.

If the image processor 20 is instructed to set the second processing function by the CPU 10 (NO in Act 201), it performs the first decoding, the first edge detection, the resolution reduction, and the background encoding as the part of high compression on the image data of the first page (Acts 206, 207, 208, and 211), and performs, as the part of high compression on the image data of the second page, for example, the second decoding and the second edge detection in spare time between the resolution reduction and the background encoding (Acts 209 and 210).

A plural-page task processing program needed to perform the first decoding, the first edge detection, the second decoding, the second edge detection, the resolution reduction, and the background encoding is stored in the ROM 12. The image processor 20 reads the plural-page task processing program from the ROM 12 when setting the second processing function.

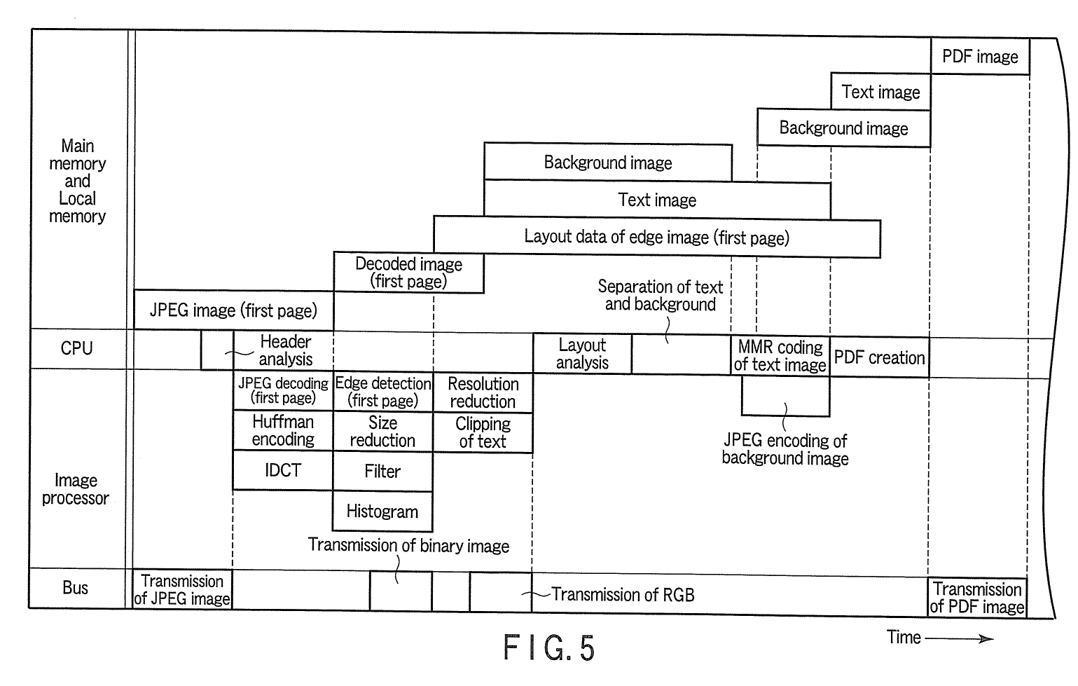

Operations of resources performed when the processing load of the image processor 20 is equal to or higher than the predetermined value are shown in FIG. 5. Namely, the image processor 20 performs the JPEG decoding, the edge detection, and the resolution reduction in this order on the image data of the first page input from the scanner 4 or the personal computer 50. Subsequently, the CPU 10 performs the layout analysis, the separation, the MMR encoding, and the PDF creation in this order. In addition, the image processor 20 performs the JPEG decoding almost simultaneously with the MMR encoding of the CPU 10. The image data created as a PDF is stored in the main memory 13, and stored in, for example, the hard disk drive 14.

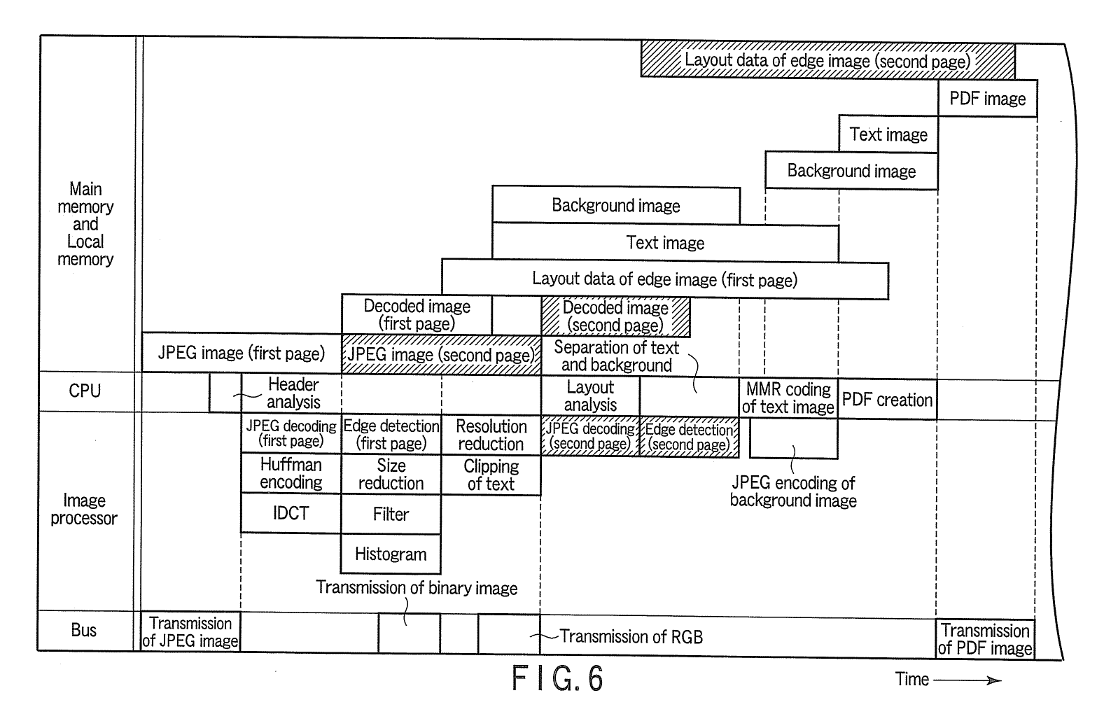

Operations of resources performed when the processing load of the image processor 20 is lower than the predetermined value are shown in FIG. 6. Namely, the image processor 20 performs the JPEG decoding (first page), the edge detection (first page), and the resolution reduction in this order on the image data of the first page input from the scanner 4 or the personal computer 50. Subsequently, the CPU 10 performs the layout analysis, the separation, the MMR encoding, and the PDF creation in this order thereon. In addition, the image processor 20 performs the JPEG decoding (second page), the edge detection (second page), and the JPEG decoding in this order almost simultaneously with the layout analysis, the separation, and the MMR encoding of the CPU 10. The image data created into PDF is stored in the main memory 13, and stored in, for example, the hard disk drive 14.

The JPEG decoding (second page) and the edge detection (second page) of the image processor 20 are performed in spare time during the processing of the image processor 20.

As such, the high compression of image data is distributed to the image processor 20 and the CPU 10 so as to be performed, so that the high compression speed is significantly increased.

Particularly, when the processing load of the image processor 20 is small, in spare time during the high compression performed by the image processor 20, the image processor 20 performs a part of the high compression of the image data of the second page. Therefore, the high compression speed of a plurality of pages of image data is further increased.

A dynamic reconfigurable processor is employed as the image processor 20, so that a plurality of functions can be implemented by the single image processor 20. Therefore, as compared with the case of using fixed hardware such as ASIC, cost can be reduced.

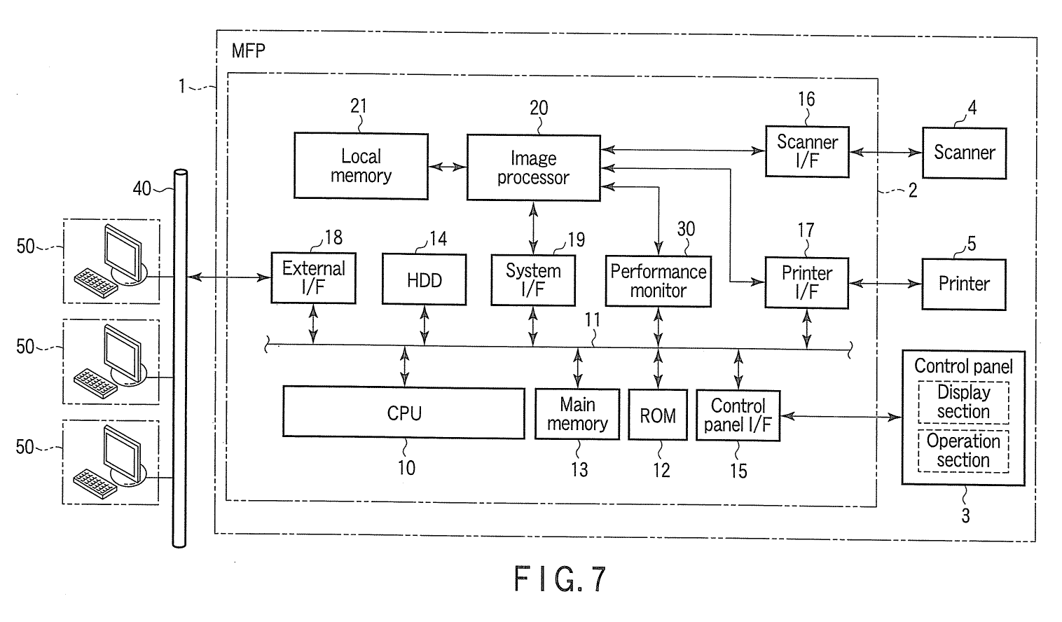

In addition, the image processing circuit 2 may be configured as shown in FIG. 7. Namely, the scanner interface 16 and the printer interface 17 are directly connected to the image processor 20. The image processor 20 has a scan control function and a print control function, in addition to the high compression function of image data, and can simultaneously perform the high compression, the scan control, and the print control. Therefore, since the image processor 20 is employed, the processing speed is significantly increased as compared with a case where only the CPU 10 performs control.

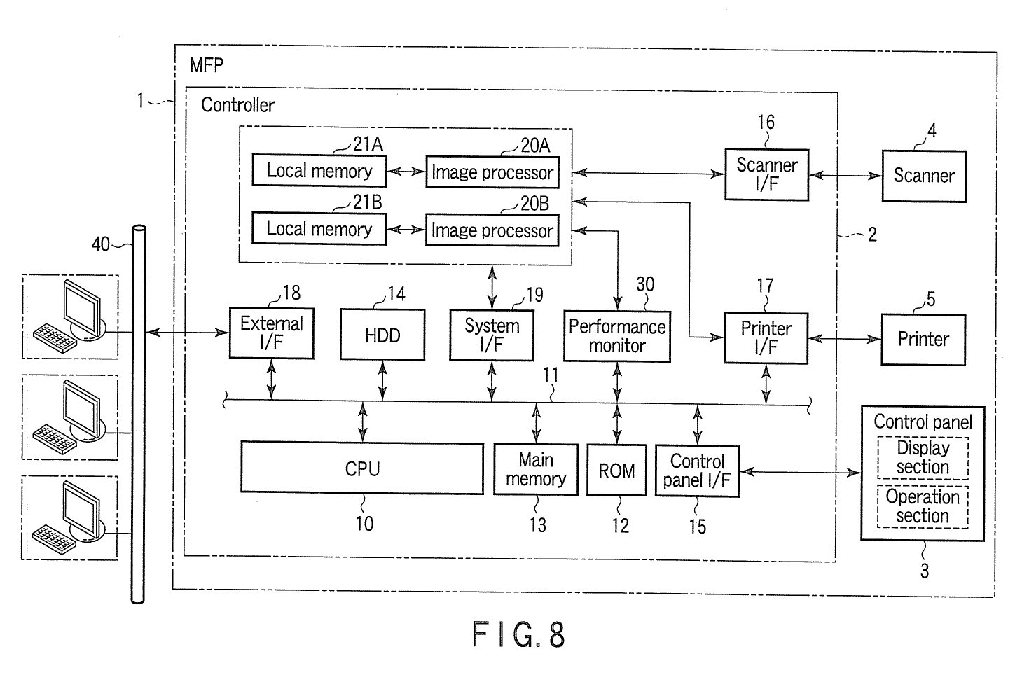

Otherwise, the image processing circuit 2 may be configured as shown in FIG. 8. Specifically, two image processors 20A and 20B and local memories 21A and 21B are employed, and the scanner interface 16 and the printer interface 17 are connected to the image processors 20A and 20B. In this case, the high compression function, the scan control function, and the print control function can be distributed to the two image processors 20A and 20B. Therefore, the processing speed can be further increased.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus comprising:
an image processor configured to selectively set a first processing function of performing a part of processing on first image data, and a second processing function of performing a part of processing on second image data while performing the part of processing on the first image data; and
a controller configured to detect a processing load of the image processor, instruct the image processor to set the first processing function if the detected load is equal to or higher than a predetermined value, instruct the image processor to set the second processing function if the detected load is less than the predetermined value, and perform the residual processing on the first image data while the image processor performs the part of processing on the first image data.

2. The apparatus of claim 1,
wherein the controller includes:
a load detection section configured to detect the processing load of the image processor;
an instruction section configured to instruct the image processor to set the first processing function if the load detected by the load detection section is equal to or higher than a predetermined value, and instruct the image processor to set the second processing function if the load detected by the load detection section is less than the predetermined value; and
one or a plurality of processing sections configured to perform the residual processing on the first image data in parallel with the part of processing which is performed on the first image data by the image processor.

3. The apparatus of claim 1, wherein the image processor includes a function setting section configured to set one of the first processing function and the second processing function according to an instruction from the controller.

4. The apparatus of claim 1, wherein the image processor is a dynamic reconfigurable processor.

5. The apparatus of claim 1,
wherein the first image data is image data of a first page, and
the second image data is image data of a second page following the first image data.

6. The apparatus of claim 1, further comprising: a performance monitor which monitors a performance of the image processor.

7. The apparatus of claim 6, wherein the load detection section detects the processing load of the image processor on the basis of a monitoring result of the performance monitor.

8. The apparatus of claim 1,
wherein the processing on the first image data is high compression of the first image data, and
the processing on the second image data is high compression of the second image data.

9. The apparatus of claim 8,
wherein a part of the high compression of the first image data includes first decoding, first edge detection, resolution reduction, and background encoding,
the residual high compression of the first image data includes layout analysis, separation, text encoding, and file creation, and
a part of the high compression of the second image data includes second decoding and second edge detection.

10. The apparatus of claim 9,
wherein the first decoding decodes the first image data,
the first edge detection detects edges of a text image region of the image data decoded by the first decoding,
the resolution reduction reduces a resolution of the image data decoded by the first decoding,
the layout analysis analyzes a layout of the text image region of the image data decoded by the first decoding,
the separation separates the image data decoded by the first decoding into text image data and background image data according to a processing result of the layout analysis and a processing result of the resolution reduction,
the text encoding encodes the text image data separated by the separation,
the background encoding encodes the background image data separated by the separation,
the file creation creates the text image data encoded by the text encoding and the background image data encoded by the background encoding into files,
the second decoding decodes the second image data, and
the second edge detection detects edges of the text image region of the image data decoded by the second decoding.

11. The apparatus of claim 10,
wherein the first processing function of the image processor includes:
a first decoding section for the first decoding;
a first edge detection section for the first edge detection;
a resolution reduction section for the resolution reduction; and
a background encoding section for the background encoding,
wherein the second processing function of the image processor includes:
the first decoding section;
the first edge detection section;
the resolution reduction section;
the background encoding section;
a second decoding section for the second decoding; and
a second edge detection section for the second edge detection, and
wherein the controller includes:
a layout analysis section for the layout analysis;
a separation section for the separation;
a text encoding section for the text encoding; and
a file creation section for the file creation.

12. A control method of an image forming apparatus including an image processor configured to selectively set a first processing function of performing a part of processing on first image data and a second processing function of performing a part of processing on second image data while performing the part of processing on the first image data, the method comprising:
detecting a processing load of the image processor;
instructing the image processor to set the first processing function if the detected load is equal to or higher than a predetermined value;
instructing the image processor to set the second processing function if the detected load is less than the predetermined value; and
performing the residual processing on the first image data while the part of processing on the first image data is performed.

13. The method of claim 12, wherein the image processor sets one of the first processing function and the second processing function according to the instruction.
